(19) United States
(12) Patent Application Publication
(10) Pub. No.: US 2014/0370290 A1
(43) Pub. Date: Dec. 18, 2014

(54) IRON NITRIDE BASED MAGNETIC POWDER AND MAGNET USING THE SAME

(71) Applicant: TDK CORPORATION, Tokyo (JP)

(72) Inventors: Hirotaka YOKOTA, Tokyo (JP); Masakazu HOSONO, Tokyo (JP); Kiyoyuki MASUSAWA, Tokyo (JP)

(21) Appl. No.: 14/300,857

(22) Filed: Jun. 10, 2014

(30) Foreign Application Priority Data
Jun. 12, 2013 (JP) 2013-123722
Apr. 4, 2014 (JP) 2014-077710

(51) Int. Cl. H01F 1/11; C01B 21/06

(52) U.S. Cl. CPC H01F 1/11; C01B 21/0622
USPC 428/402; 252/62.51 R

(57) ABSTRACT

The present invention provides an iron nitride based magnetic powder which comprises the Fe₁₆N₂ phases and the Fe₄N phases. The iron nitride based magnetic powder of the present invention is obtained by subjecting the iron oxide or the starting material to an reduction treatment and a nitriding treatment, wherein the starting material is obtained by covering the surfaces of the iron oxide particles by a Si-based compound as required. The iron nitride based magnetic powder consists of 70 at % or more and 95 at or less of the phases of Fe₁₆N₂. compound and 5 at % or more and 30 at % or less of the phases of Fe₄N compound in terms of Fe as measured by the Mossbauer spectra.

The present invention relates to a magnetic powder with a high coercivity in which phases of Fe₁₆N₂ compound and phases of Fe₄N compound are contained.

### BACKGROUND

The Fe—N based compound especially Fe₁₆ N₂ is attracting attentions as one of the materials that exhibit greater saturation magnetization than Fe. In addition, it is well known that the Fe₁₆N₂ phase is a metastable compound generated by subjecting the martensite phase to an annealing treatment for a relatively long time, wherein the martensite phase is obtained by quenching the austenite which contains nitrogen. However, as it is referred to as a metastable compound, the powder of such an isolated compound is extremely hard to be chemically synthesized.

Further, it has been described in Patent Document 1 or Patent Document 2 that Fe₁₆N₂ is obtained by generating a metallic iron powder and then subjecting the obtained metallic iron powder to a nitriding treatment. However, the value of the coercivity is too low to be used in practice. Thus, it is hard to say that the obtained Fe₁₆N₂ is a suitable magnetic material.

### PATENT DOCUMENT

Patent Document 1: JP 2009-249682

Patent Document 2: JP 2000-277311

### SUMMARY

In view of the technical problems mentioned above, the present invention has been completed. This invention aims to provide a Fe—N based magnetic powder with a higher coercivity as well as a magnet using such a magnetic powder.

The present invention (Invention 1) is a magnetic powder characterized in that it is a magnetic powder having the phases of Fe₁₆N₂ compound and the phases of Fe₄N compound, wherein the phases of Fe₁₆N₂ compound are 70 at % or more and 95 at % or less and the phases of Fe₄N compound are 5 at % or more and 30 at % or less in terms of Fe as measured by the Mossbauer spectra. With the ranges mentioned above, pinning sites can be introduced to prevent the magnetization reversal of Fe₁₆N₂ so that a high coercivity can be obtained.

The preset invention (Invention 2) is a magnetic powder of Invention 1, characterized in that N accounts for 3 mass % or more and 6 mass % or less. With such a range, heterogeneous phases other than those of Fe₁₆N₂ compound and Fe₄N compound can be prevented from generating and a higher coercivity can be obtained.

In addition, the present invention (Invention 3) is a magnetic powder of Invention 1 or invention 2, characterized in that the specific surface area is 10 m²/g or more and 80 m²/g or less. By controlling the specific surface area, the main causes leading to the decreasing of coercivity can be under control and a high coercivity can be obtained.

Further, the present invention (Invention 4) is magnet which uses magnetic powder of any one of Invention 1 to Invention 3.

According to the present invention, a Fe—N based magnetic powder which contains Fe₁₆N₂ phases and Fe₄N phases and has a high coercivity can be obtained as well as the magnet.

### DETAILED DESCRIPTION OF EMBODIMENTS

Hereinafter, the preferable embodiments of the present invention will be described. However, the present invention is not limited to the embodiments and examples to be described below. In addition, the constituents shown in these embodiments and examples can be appropriately combined or selected.

The magnetic powder of the present embodiment is composed of 70 at % or more and 95 at % or less of the phases of Fe₁₆N₂ compound and 5 at % or more and 30 at % or less of the phases of Fe₄N compound in terms of Fe as measured by the Mossbauer spectra. In the single-phase of Fe₆N₂, the phases of Fe₁₆N₂ compound will not be magnetically isolated because of the sintering occurred among grains. When the phases of Fe₁₆N₂ compound are 70 at % or more and 95 at % or less and the phases of Fe₄N compound are 5 at % or more and 30 at % or less, the phases of Fe₄N compound among the phases of Fe₁₆N, compound become the pinning sites which inhibit the magnetization reversal of Fe₁₆N₂ so that the coercivity is improved. When the phases of Fe₁₆N₂ compound are a level below 70 at % or the phases of Fe₄N compound are a level higher than 30 at %, the ratio of phases other than those of the Fe₁₆N₂ compound (the phase of Fe₁₆N₂ compound is a hard magnetic phase) becomes higher. In this respect, it is not likely to obtain a sufficient coercivity no matter how much of the phases of the Fe₄N compound is contained. When the phases of the Fe₄N compound are a level below 5 at %, it is not possible to obtain a sufficient pinning effect so that the coercivity might not be improved either. Based on such a view, the magnetic powder of the present embodiment is preferably composed of 80 at % or more and 95 at % or less of the phases of Fe16N2 compound and 5 at % or more and 20 at % or less of the phases of Fe₄N compound as measured by the Mossbatier spectra.

The magnetic powder of the present embodiment preferably contains 3 mass % or more and 6 mass % or less of N. When the amount of N is less than 3 mass %, the phases of α-Fe compound are generated and the coercivity tends to decrease. It the amount of N is more than 6 mass %, the ratio occupied by the phases of Fe₁₆N₂ compound becomes small and the coercivity tends to decrease.

In the magnetic powder of the present embodiment, the specific surface area is preferably 10 m²/g or more and 80 m²/g or less. When the specific surface area is smaller than 10 m²/g, the ratio occupied by the particles of the critical size of the single magnetic domain or even smaller is quite low due to the large particle size. In this respect, the coercivity tends to decrease. When the specific surface area is larger than 80 m²/g, the ratio of the film of oxide becomes larger in the particle surface, or the particle size is small. Thus, the powder behaves as superparamatmetism. In this way, the coercivity tends to decrease. it is more preferable that the specific surface area is 15 m²/g or more and 70 m²/g or less.

In the present embodiment, the coercivity Hc of the magnetic powder is preferably 1800 Oe or more. When the coercivity Hc is below that range, it is hard to say that the magnetic powder has sufficient magnetic properties. In addition, the coercivity Hc is more preferably 2000 Oe or more.

Hereinafter, the preferable method for preparing the magnetic powder of the present embodiment will be described.

The magnetic powder of the present embodiment can be obtained by using an Iron oxide 1 with a specific surface area of 30 m²/g or more and 150 m²/g or less and an iron oxide 2 with a specific surface area of 160 m²/g or more and 300 m²/g or less as the starting materials and then subjecting these starting. materials to a reduction treatment followed by a nitriding treatment.

There is no particular restriction on the iron oxide which is the starting material. For example, the iron oxide can be the magnetite, γ-Fe₂O₃, α-Fe₂O₃, α-FeOOH, β-FeOOH, γ-FeOOH, FeO or the like.

Also, the shape of the iron oxide particles of the starting material is not particularly restricted. For example, the particles can he needle-like, granular, fusiform, cuboid or the like.

In the present embodiment, the Iron oxide 1 with a specific surface area of 30 m²/g or more and 150 m²/g or less and the Iron oxide 2 with as specific surface area of 160 m²/g or more and 300 m²/g or less are used in combination as the iron oxide (which is the starting material). As such two kinds of iron oxides are used, the phases of Fe₄N compound are generated during the nitriding treatment besides the phases of FeN₁₆N₂ compound. If the specific surface area of the Iron oxide 1 is less than 30 m²/g , it is hard to perform the nitriding process. Accordingly, it is hard to obtain the targeted magnetic powder consisting of 70 at % or more of the phases of Fe₁₆N₂ compound (in terms of Fe as measured by the Mossbauer spectra). If the specific surface area of the Iron oxide 1 is higher than 150 m²/g, excessive nitriding will occur so that it is easily to generate 5 at % or more of the phases of Fe₄N compound as measured by the Mossbauer spectra. However, in this case, it is hard to obtain the magnetic powder composed of 70 at % or more of the phases of Fe₁₆N₂ compound. If the specific surface area of the Iron oxide 2 is lower than 160 m²/g , it is hard to perform the nitriding process. Accordingly, it is hard to obtain the targeted magnetic powder consisting of 5 at % or more of the phases of Fe₄N compound. If the specific surface area of the Iron oxide 2 is larger than 300 m²/g , excessive nitriding will occur so that the phases of Fe₄N compound will be more than 30 at %. The specific surface area of the Iron oxide 1 is further preferably 45 m²/g or more and 140 m²/g or less, and more preferably 50 m²/g or more and 130 m²/g or loss. In addition, the specific surface area of the Iron oxide 2 is further preferably 170 m²/g or more and 290 m²/g or less, and more preferably 180 m²/g or more and 280 m²/g or less.

In the present embodiment, if required, the Si-based compound can be used to cover the surface of the iron oxide so as to inhibit the sintering occurred among particles due to the reduction treatment.

After the pH value of the aqueous suspension which is obtained by dispersing the iron oxide particles is adjusted, the Si-based compound is added and been the mixture is stirred and mixed. Alternatively, if necessary, the pH value is adjusted after the mixture is stirred. In this respect, the Si-based compound covers the surface of the iron oxide particles. Thereafter, the powder is obtained by a washing process with water, a drying process and a pulverizing process.

The sodium orthosilicate, sodium metasilicate, colloidal silica, the silane coupling agent and the like can be used as the Si-based compound.

With respect to the iron oxide, the amount of the Si-based compound as the cover is preferably 0.1 mass % or more and 20 mass % or less in terms of Si. When the amount of Si-based compound is less than 0.1 mass %, it is hard to determine whether the sintering occurred among particles can be sufficiently inhibited during the heat treatment. Further, it is not preferable if the amount of the Si-based compound is more than 20 mass % because the nonmagnetic components will increase. In addition, it is further preferable that the amount of the Si-based compound to cover the surface is 0.15 mass % or more and 15 mass % or less, and more preferably 0.2 mass % or more and 10 mass % or less.

Next, the iron oxides or those with their surfaces covered by the Si-based compound are subjected to the reduction treatment.

The temperature in the reduction treatment is preferably 200 to 600° C. If the temperature is lower than 200° C. during the reduction treatment, the iron oxides will not be sufficiently reduced to metallic iron. On the other hand, it is not preferable if the temperature during the reduction treatment is higher than 600° C., either. In that case, although the icon oxides will be sufficiently reduced, the sintering will occur among particles. The temperature for reduction is more preferably 250 to 450° C.

There is no particular restriction on the duration of the reduction treatment. However, the duration is preferably 1 to 96 hours. If the duration is longer than 96 hours, the sintering will occur due to the reduction temperature. In this way, it is hard to perform the subsequent nitriding treatment. If the duration is shorter than 1 hour, the reduction process will not be sufficiently performed in many cases. The more preferable duration for the reduction treatment is 2 to 72 hours.

The atmosphere for the reduction treatment is preferred to be the hydrogen atmosphere.

The reduction treatment is followed by the nitriding treatment.

The temperature for the nitriding treatment is 100 to 200° C. When the temperature during the nitriding treatment is lower than 100° C., the nitriding treatment cannot be sufficiently performed. When the temperature during the nitriding treatment is higher than 200° C., the nitriding will be over performed so that the targeted magnetic powder cannot be obtained, wherein the magnetic powder consists of 70 at % or more of the phases of Fe₁₆N₂ compound in terms of Fe as measured by the Mossbauer spectra. Further, the more preferable reduction temperature is 120 to 180° C.

The duration for the nitriding treatment is not particularly restricted and is preferred to be 1 to 48 hours. If the duration is longer than 48 hours, the targeted magnetic powder cannot be obtained because of the nitriding temperature, wherein the targeted magnetic powder consists of 70 at % or more of the phases of Fe₁₆N₂ compound in terms of Fe as measured by the Mossbauer spectra. If the duration is less than 1 hour, the nitriding process will not be sufficiently performed in most cases. Further, 3 to 24 hours are more preferable.

The atmosphere for the nitriding treatment is better to be NH₃. Besides NH₃, N₂, H₂ or the like can be used in combination.

A magnet such as a bulk magnet or an anisotropic bond magnet can be yielded by using the iron nitride powder obtained in the present embodiment. The production method thereof will be described below.

Firstly, an example will be provided about the method for producing the bulk magnet. The iron nitride powder obtained in the present embodiment can be made into the bulk magnet by the compression molding process. Here, the conditions for the compression molding process are not particularly limited and can be properly adjusted to achieve the required properties of the produced bulk magnet. For example, the pressure in the compression molding process can he controlled to 1 to 10 ton/cm². In addition, the orientation in a magnetic field can be performed during the molding process. Further, a lubricant or a resin can be applied to the surface of the iron nitride powder.

Next, an example of the method for producing the anisotropic bond magnet by using the iron nitride powder of the present embodiment will be described. For example, a pressurized mixer such as a pressurized kneader is used to mix a resin-containing resin binder and the magnetic powder so as to prepare the compound (composition) for the bond magnet. The resin includes for example the thermosetting resin such as the epoxy resin, phenolic resin and the like; or the thermoplastic resin such as the styrene-based, olefin-based, urethane-based, polyester-based, polyamide-based elastomer, ionomer, ethylene-propylene copolymer (EPM), ethylene-ethyl acrylate copolymer and the like. If the compression molding process is performed, the resin to be used is preferably the thermosetting resin, and more preferably the epoxy resin and the phenolic resin. In addition, if the injection molding process is to be performed, the used resin is preferably the thermoplastic resin. Further, as coupling agent or other additive materials can be added in the compound for the bond magnet if required.

With respect to the ratios of the magnetic powder and the resin contained in the bond magnet, it is preferable that for example 0.5 mass % or more and 20 mass % or less of resin is contained relative to 100 mass % of the magnetic powder. If the less than 0.5 mass % of resin is contained relative to 100 mass % of magnetic powders, the firmness tends to deteriorate. If more than 20 mass % of resin is contained, it tend to be hard to be obtain sufficiently excellent magnetic properties.

After the preparation of the compound for bond magnet mentioned above, the compound for bond magnet is subjected to an injection molding process so that a bond magnet containing the magnetic powder and the resin can be obtained. If the bond magnet is produced by the injection molding process, the compound for bond magnet is heated to the melting temperature of the binder (the thermoplastic resin) as needed. Then, when the compound for bond magnet comes into a flow status, it is injected into a mold with a specified shape and then molded there. After that, the molded article (i.e., the bond magnet) with a specified shape is cooled and then taken out from the mold In this way, a bond magnet is yielded. The method for producing the bond magnet is not limited to the method mentioned above involving the injection molding process. For example, the compound for bond magnet can be subjected to a compression molding process to obtain the bond magnet containing the magnetic powder and the resin. If the compression molding process is used to produce the bond magnet, the compound for bond magnet is prepared and then filled into a mold with specified shape. After the application of pressures, the molded article (i.e., the bond magnet) with a specified shape is taken out from the mold. If the compound for bond magnet is molded in as mold and then taken out of the mold, the process is done in a compression molding machine such as a mechanical press, an oil hydraulic press or the like. Thereafter, the molded article of the bond magnet with a specified shape is put into a heating furnace or a vacuum drying oven where it is heated and hardened. In this way, a bond magnet is obtained.

The shape of the molded bond magnet is not particularly restricted. Corresponding to the shape of the mold in use such as a plate-like shape, a columnar shape and a shape with the section being a ring, the shape of the bond magnet vary accordingly. In addition, in order to prevent the oxide layer, the resin layer and the like of the resulting bond magnet from deteriorating, the surface may be subjected to plating or coating.

When the compound fur bond magnet is molded into an intended predetermined shape, the molded body derived from the molding process may also be oriented in a specific direction by applying a magnetic field. Thus, an anisotropic bond magnet with better magnetic performances is obtained, because the bond magnet has been oriented in a specific direction.

### EXAMPLES

The present invention will be further described in detail based on the following Examples and Comparative Examples.

### Description on the Measuring Methods

First of all, the measuring methods in the Examples and Comparative Examples will be described. The specific surface areas of the iron oxides starting materials and resulting magnetic powders are measured by the BET method using nitrogen. The compositions of the iron oxides starting materials and the resulting magnetic powders are obtained by dissolving the heated samples with an acid and then measuring them by an inductively-coupled plasma spectrometer (ICP, ICPS-8100CL, produced by Shimadzu Corporation). The constituent phases of the iron oxides starting materials and the resulting magnetic powders are identified by a X-ray powder diffraction apparatus (XRD, RINT-2500, produced by Rigaku Corporation, Japan) and a Mossbauer spectrometer. The magnetic properties of the resulting magnetic powder are measured in a magnetic field of 0 to 20000 Oe under 296K by using a vibrating sample magnetometer (VSM, VSM-5-20, produced by Toei Industry Co., Ltd.). The Mossbauer measurements of the resulting magnetic powders are performed under a sealing condition in a glovebox with argon atmosphere where the magnetic powders are put into a laminate pack. The peak analyses in the Mossbauer spectra are done by performing the curve fitting with the spectra being assumed as the ideal linear sum, determining the position of the peak and then calculating the peak area of each component. If the peak belongs to the bilaterally symmetric Lorentz type, full-width at half-maximum of each component will be the same and the peak heights at symmetric positions are respectively equal. In this respect, the relative area ratio of each peak obtained like this is directly used as the relative composition ratio so that the generation ratios of Fe₁₆N₂ and Fe₄N are calculated.

### Example 1

### Preparation of the Starting Materials

Iron oxide 1 with a specific surface area of 115 m²/g was prepared by using the ferrous sulphate, feric chloride and sodium hydroxide. Iron oxide 2 with is specific surface area of 187 m²/g was prepared by the same method. These two kinds of resulting iron oxides were mixed in a dispersion liquid and the dispersion liquid was stirred for 2 hours under room temperature. Thereafter, the dispersion liquid was left to stand for several hours and the supernatant was then removed. Subsequently, 200 ml of pure water was added relative to 1 g of the resulting sample and then the supernatant was removed. This step was repeated for 7 times. The remaining substances were dried in a vacuum dryer of 85° C. and were then pulverized by a mortar and a pestle.

### Reduction Treatment and Nitriding Treatment to the Starting Materials

Five grams of the resulting powder were put into an ashtray for ash measurement (50 mm×30 mm×10 mm (depth)) and then left to stand in as furnace for heat treatment. After the furnace was filled with the nitrogen gas, hydrogen gas was allowed to flow at a flow rate of 1 L/min while the temperature was raised to 250° C. with a rate of 5° C./min. The conditions were maintained for 12 hours to conduct the reduction treatment. Then, the supply of the hydrogen gas was stopped. In the meanwhile, the nitrogen gas was allowed to flow at a flow rate of 2 L/min and the temperature was decreased to 160° C. Subsequently, the ammonia gas was allowed to flow at a flow rate of 0.1 L/min while the nitriding treatment was performed for 12 hours at a temperature of 160° C. Then, the nitrogen gas flowed at a flow rate of 2 L/min and the temperature was decreased to 50° C. After that, the gas was replaced with air and the replacement process continued for 12 hours. In this way, the sample was obtained.

### Example 2

The starting materials, Iron oxide 1 and iron oxide 2, were produced in the same way as in Example 1. Then, 50 ml of pure water was added relative to 1 g of the sample. The mixture was stirred while the aqueous solution of sodium orthosilicate was added to make Si accounted for 1.0 mass %. To 1 g of the obtained sample, 200 mL of pure water was added again. The mixture was left to stand for several hours and then the supernatant was removed. The obtained sample was washed in this way. Then, the washed sample was dried in a vacuum dryer of 85° C. and then pulverized by a mortar and a pestle. The content of Si in the obtained sample was 1.0 mass %.

Thereafter, the reduction treatment and the nitriding treatment were done. The sample was produced with the same conditions as in Example 1 except that the reduction treatment lasted for 24 hours at 300° C. and the nitriding treatment was performed for 9 hours at 150° C.

As for Examples 3 to 14 and Comparative Examples 1 to 10, the samples were prepared by the same method as Example 2 except that the specific surface area and the content of Si for Iron oxide 1 and Iron oxide 2, the conditions for the reduction treatment, the conditions for the nitriding treatment and the conditions for the air replacement were used in accordance with those listed in Table 1.

### Evaluations

With respect to the samples obtained in Examples 1 to 14 and Comparative Examples 1 to 10, the ratios of the phases of Fe₁₆N₂ compound and the phases of Fe₄N compound as measured by the Mossbauer spectra, the specific surface areas, the contents of N and the coercivities had their results shown in Table 1.

TABLE 1

| | Iron oxide starting materials | | | Conditions for heat treatment | | | | |
|---|---|---|---|---|---|---|---|---|
| | Iron oxide 1 | Iron oxide 2 | | | | | | |
| | Specific surface | Specific surface | | Reduction treatment | | Nitriding treatment | | Air replacement |
| | area | area | Content of Si | Temperature | Duration | Temperature | Duration | Duration |
| | [m²/g] | [m²/g] | [mass %] | [° C.] | [h] | [° C.] | [h] | [h] |
| Example 1 | 115 | 187 | 0.0 | 250 | 12 | 160 | 12 | 12 |
| Example 2 | 115 | 187 | 1.0 | 300 | 24 | 150 | 9 | 12 |
| Example 3 | 115 | 187 | 2.0 | 370 | 24 | 140 | 6 | 12 |
| Example 4 | 34 | 187 | 2.0 | 370 | 24 | 140 | 6 | 12 |
| Example 5 | 147 | 187 | 2.0 | 370 | 24 | 140 | 6 | 12 |
| Example 6 | 115 | 164 | 2.0 | 370 | 24 | 140 | 6 | 12 |
| Example 7 | 115 | 295 | 2.0 | 370 | 24 | 140 | 6 | 12 |
| Example 8 | 115 | 187 | 4.0 | 420 | 48 | 130 | 24 | 24 |
| Example 9 | 147 | 295 | 4.0 | 420 | 48 | 130 | 24 | 24 |
| Example 10 | 115 | 187 | 0.0 | 250 | 24 | 160 | 24 | 12 |
| Example 11 | 115 | 187 | 2.0 | 370 | 24 | 140 | 4 | 12 |
| Example 12 | 115 | 187 | 2.0 | 370 | 24 | 140 | 24 | 12 |
| Example 13 | 115 | 187 | 4.0 | 420 | 48 | 120 | 48 | 24 |
| Example 14 | 115 | 187 | 4.0 | 420 | 48 | 120 | 24 | 24 |
| Comparative | 115 | — | 0.0 | 250 | 12 | 160 | 12 | 12 |
| Example 1 | | | | | | | | |
| Comparative | 115 | — | 2.0 | 370 | 24 | 140 | 6 | 12 |
| Example 2 | | | | | | | | |
| Comparative | — | 187 | 2.0 | 370 | 24 | 140 | 6 | 12 |
| Example 3 | | | | | | | | |
| Comparative | 28 | 187 | 2.0 | 370 | 24 | 140 | 6 | 12 |
| Example 4 | | | | | | | | |
| Comparative | 155 | 187 | 2.0 | 370 | 24 | 140 | 6 | 12 |
| Example 5 | | | | | | | | |
| Comparative | 115 | 155 | 1.0 | 300 | 24 | 150 | 9 | 12 |
| Example 6 | | | | | | | | |
| Comparative | 115 | 155 | 2.0 | 370 | 24 | 140 | 6 | 12 |
| Example 7 | | | | | | | | |
| Comparative | 115 | 310 | 2.0 | 370 | 24 | 140 | 6 | 12 |
| Example 8 | | | | | | | | |
| Comparative | 155 | 295 | 2.0 | 370 | 24 | 140 | 6 | 12 |
| Example 9 | | | | | | | | |
| Comparative | 155 | 310 | 4.0 | 420 | 48 | 130 | 24 | 24 |
| Example 10 | | | | | | | | |

| | Iron nitride | | | | |
|---|---|---|---|---|---|
| | Mossbauer spectra | | Specific surface | | |
| | Fe₁₆N₂ | Fe₄N | area | Content of N | Coercivity |
| | [%] | [%] | [m²/g] | [mass %] | [Oc] |
| Example 1 | 78 | 15 | 12 | 3.5 | 2060 |
| Example 2 | 92 | 5 | 25 | 3.3 | 2380 |
| Example 3 | 83 | 6 | 37 | 3.2 | 2840 |
| Example 4 | 72 | 8 | 36 | 3.2 | 2240 |
| Example 5 | 75 | 12 | 39 | 3.4 | 2320 |
| Example 6 | 70 | 10 | 35 | 3.3 | 2110 |
| Example 7 | 70 | 28 | 40 | 3.8 | 2030 |
| Example 8 | 72 | 22 | 66 | 4.7 | 2270 |
| Example 9 | 75 | 21 | 78 | 5.8 | 2180 |
| Example 10 | 75 | 10 | 8 | 3.3 | 1900 |
| Example 11 | 80 | 5 | 37 | 2.5 | 1970 |
| Example 12 | 73 | 23 | 37 | 6.6 | 1990 |
| Example 13 | 73 | 14 | 87 | 3.7 | 1950 |
| Example 14 | 71 | 10 | 84 | 2.7 | 1870 |
| Comparative | 68 | 8 | 8 | 3.5 | 1140 |
| Example 1 | | | | | |
| Comparative | 77 | 3 | 36 | 3.0 | 1720 |
| Example 2 | | | | | |
| Comparative | 65 | 15 | 38 | 2.9 | 1480 |
| Example 3 | | | | | |
| Comparative | 67 | 10 | 36 | 2.6 | 1440 |
| Example 4 | | | | | |
| Comparative | 67 | 17 | 42 | 3.4 | 1710 |
| Example 5 | | | | | |
| Comparative | 96 | 2 | 20 | 3.2 | 1790 |
| Example 6 | | | | | |
| Comparative | 66 | 7 | 35 | 3.1 | 1580 |
| Example 7 | | | | | |
| Comparative | 54 | 33 | 45 | 4.2 | 510 |
| Example 8 | | | | | |
| Comparative | 66 | 31 | 38 | 3.9 | 1560 |
| Example 9 | | | | | |
| Comparative | 65 | 24 | 83 | 6.2 | 1750 |
| Example 10 | | | | | |

Each sample obtained in these Examples had a relatively higher coercivity compared to those of Comparative Examples. The reason was believed to be that the generated phases of Fe4N compound inhibited the motion of the domain walls of the phases of Fe₁₆N₂ compound. As shown in Comparative Example 4 to Comparative Example 10, when the generation ratio of either the phases of Fe₁₆N₂ compound or those of Fe4N compound was beyond the ranges defined in the claims, it would be hard to control the generated compound phases. Also, the coercivity would be decreased.

In addition, a bulk magnet was prepared by subjecting the iron nitride powders of Example 3 to a compression molding process. The compression molding process was done under atmosphere with as pressure of 3 ton/cm². Thus obtained bulk magnet had a coercivity of 3050 Oe. Therefore, it can be known that a bulk magnet which is applicable to actual applications sufficiently can be obtained by using the iron nitride magnetic powder of the present application.

What is claimed is:

1. An iron nitride based magnetic powder, wherein,
the content of the phase of Fe₁₆N₂ compound is 70at % or more and 95 at % or less and the content of the phase of Fe₄N compound is 5 at % or more and 30 at % or less, in terms of Fe, measured by the Mossbauer spectra.

2. The iron nitride based magnetic powder of claim 1, wherein,
the content N is 3 mass % or more and 6 mass % or less.

3. The iron nitride based magnetic powder of claim 1, wherein,
the specific surface area is 10 m²/g or more and 80 m²/g or less.

4. The iron nitride based magnetic powder of claim 2, wherein,
the specific surface area is 10 m²/g or more and 80 m²/g or less.

5. A magnet obtained by using the iron nitride based magnetic powder of claim 1.

6. A magnet obtained by using the iron nitride based magnetic powder of claim 2.

7. A magnet obtained by using the iron nitride based magnetic powder of claim 3.

8. A magnet obtained by using the iron nitride bases magnetic powder of claim 4.
